(19) United States
(12) Patent Application Publication
(10) Pub. No.: US 2021/0260696 A1
(43) Pub. Date: Aug. 26, 2021

(54) AN ENCLOSURE FOR CONDUCTING HOT WORKS

(71) Applicant: Chandanam Parambathu RAJESH PANTHAVOOR, Kuala Belait (BN)

(72) Inventor: Chandanam Parambathu RAJESH PANTHAVOOR, Kuala Belait (BN)

(21) Appl. No.: 17/255,309

(22) PCT Filed: Aug. 23, 2019
(86) PCT No.: PCT/BN2019/050001

§ 371 Date: Dec. 22, 2020

(30) Foreign Application Priority Data
Jun. 23, 2018 (BN) BN/N/2018/0061

(51) Int. Cl. B23K 26/12; B23K 37/00

(52) U.S. Cl. CPC B23K 26/127; B23K 37/006

(57) ABSTRACT

The present invention relates to a compact hot work enclosure (10) that allows quick installation and is intended to carry out minor hot works safely in a potentially flammable gas environment. In particular, it allows the hot works to be carried out by technicians outside the enclosure by inserting their hand(s) through a glove section (22). Visibility is ensured by large view panel(s) (16) which consists of large transparent window(s) made up of high impact resistant fire retardant materials. Other panels of the enclosure are made from high temperature resistant materials. Positive pressure will be maintained in the enclosure using air supply from a blower or an inert gas supply from a cylinder. The enclosure components can be transported in handbags and can be assembled and de-assembled quickly.

### FIELD OF THE INVENTION

The present invention relates to enclosure for conducting hot works. In particular, it relates to a compact enclosure for conducting minor hot works that can be installed relatively quickly in onshore or offshore installations.

### BACKGROUND TO THE INVENTION

Carrying out hot works, such as welding, cutting, grinding, sandblasting, drilling with electrical drilling machines, etc., in live hydrocarbon facilities or adverse weather conditions has always been a challenge, especially to off-shore platforms. With respect to repairs required in a vessel/tank, such repair works can be only carried out when the vessel/tank is purged of all traces of hydrocarbon gas, and especially during the facility shutdown.

In response to this, current technologies are available where a separate habitat or chamber is constructed. For example, various pressurized habitats or chambers are available in the market that provides a safe containment for the heat sources by maintaining a positive pressure there within. Such habitats or chambers can house multiple workers and works in the same way as that of an accommodation block on an off-shore platform by creating a virtual air-lock within the chamber that is maintained by means of continuous air-flow input and extraction. Typically, a specific ratio is maintained for input to extraction ensuring the chamber is inflated all times and that the air inside is clean and free of outside contaminants. This is to provide cleaner air for the workers to breathe and remove the welding fumes within the containment.

Any fumes within the conventional habitats or chambers are dispersed outside to a safe, non-flammable area through appropriate flame-retardant ducting.

Thus, the overpressure is used to prevent ingress of potentially explosive substances and gases. The work can thus be carried out in areas otherwise considered as hazardous. This allows the execution of hot works during regular operation of oil and gas related installations and plants without them having to be shut-down.

The difficulty with the current solutions is that they require a large area to set up, in view that the smallest sizes of the habitat or chamber is typically in a 2×2×2 meter arrangement or larger. To support this, scaffolding is required. In particularly, the conventional habitats or chamber are generally needs to be installed and certified by scaffolding technicians/inspectors and is generally a lengthy process and involves high costs. Furthermore, these conventional habitats or chambers require large compressors or big blowers to maintain its pressurized condition. Transportation and lifting are always a challenge especially in distant offshore locations and adverse weather conditions. Therefore, the requirement of the large compressor or big blowers would further contribute to higher operating cost for setting up the conventional habitats or chambers. There is no alternative for the bulky blowers and ducts as compressed air or inert gas/nitrogen cannot be used directly in these conventional habitats or chamber as it may endanger the wellbeing of the workers conducting the hot works inside. In some cases, the compressed air from the air compressor is used to drive the blowers or venturis for the air input to the chamber.

Typically, 4 or 5 people are required to set up the conventional habitats or chambers and carry out the hot work in a location. This is exacerbated by the fact that man power is costly in an offshore installation regardless whether the repair works are minor or intensive.

In the past, energy industries have been considered as a very profitable business and hence little attention was paid to the cost of repairs. However, this has changed in the recent years and there is a need to provide for a hot work habitat that is much cheaper to install and operate especially, when it involves small repairs.

The object of this invention is to alleviate the above problems, or at least provide the public with a useful alternative for minor hot works.

### SUMMARY OF THE INVENTION

In a first aspect the invention comprise an enclosure comprising a plurality of panels including at least one panel that includes a glove extending into the enclosure and a transparent panel to allow viewing inside the enclosure wherein the glove is used to handle equipment to work on an item within the enclosure and wherein the inside of the enclosure is pressurized above the ambient air pressure. In typical case, multiple transparent and multiple glove entry panels will be used to ease the work. The hot work is safeguarded by a control system which controls the pressure, gas detection linked to the shutdown of whole unit incase of a gas detection or emergency.

It should be noted that any one of the aspects mentioned above may include any of the features of the embodiments described below as appropriate.

### BRIEF DESCRIPTION OF THE DRAWINGS

Preferred features, embodiments and variations of the invention may be discerned from the following detailed description which provides sufficient information for those skilled in the art to perform the invention. The detailed description is not to be regarded as limiting the scope of the preceding summary of the invention in any way. The detailed description will make reference to a number of drawings as follows.

FIG. 1 is a schematic drawing illustrating a working enclosure according to a preferred embodiment of the present invention;

FIG. 2 is a side schematic view of the working enclosure according to a preferred embodiment of the invention; and

FIG. 3 is the control system flow chart used in the working enclosure according to a preferred embodiment of the present invention.

FIG. 4 is a working enclosure with multiple view and glove panels according to a preferred embodiment of the invention within a frame; and

FIG. 5 is a working enclosure that is assembled without frames according to a preferred embodiment of the invention.

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

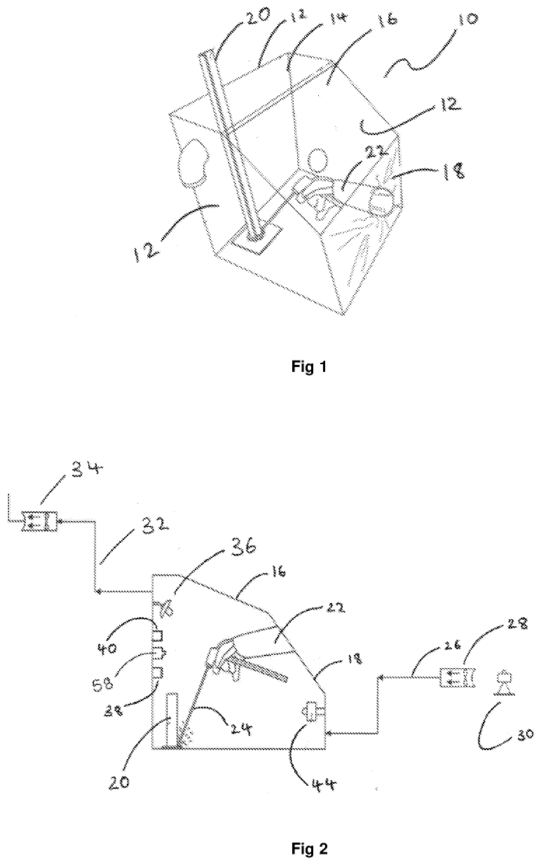

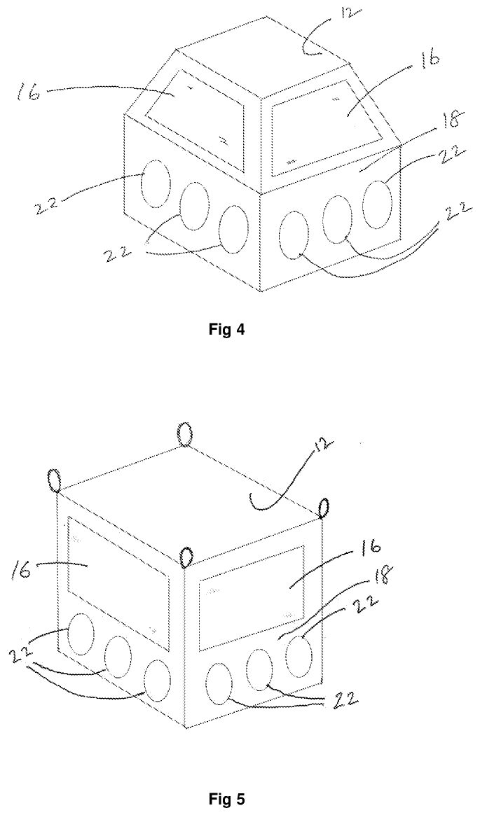

Turning now to FIGS. 1 and 2, there is illustrated a working enclosure 10 having a bottom panel, a top panel, and side and rear panels extending up from the bottom panel to define an interior. A penetration panel 14 that is located at the top of the enclosure. In one embodiment, the enclosure may include multiple penetration panels that may be located at the bottom or at the sides of the enclosure. A transparent panel, preferably includes an explosive proof glass panel 16 is located at the front between the penetration panel 14 and a front panel 18. In one embodiment, the explosive proof glass panel (16) is made up of high impact and flame retardant materials. The enclosure 10 includes a sample structure 20 that needs to be worked upon, in this case, as illustrated in FIGS. 1 and 2, the structure is as a straight angle bar. In one embodiment, the structure may include other structures such as pipes. When the structure is small it may be wholly contained within the enclosure 10 or it may protrude though the penetration panel 14 of the enclosure 10. The side panels 12 can be a penetration panel 14 if the site condition demands. In one embodiment, multiple view and glove panels (with transparent panel and gloves entry) as shown in FIG. 4 can be installed to replace the side or rear panels 12 if required.

Where the structure needs to be moved, the aperture in the penetration panel 14 may include suitable bearings (not shown) to assist in the movement.

The enclosure panels may be made of various materials such as ceramic fibre and/or silica compound material cloth or fabric that has a high temperature resistance, for example, which is able to withstand a temperature of more than 1000° C. In one embodiment, the enclosure 10 is designed to house high temperature items such as welding splatters or metals. A liner will be provided outside of the panels for better air seal which is made of tarpaulin or similar material. In one embodiment, the liner material is fire retardant. The panels can be joined to each other using a fastener that made of high temperature and flame resistant/retardant materials, for example, zipper or Velcro® fastener. In some cases, the panels may have stainless steel entry ports to accommodate various control cables for plug and play.

The enclosure panels can be assembled and dissembled quickly and do not require scaffolding. One person can set up or dissemble the enclosure 10 in less than half an hour. Normally Quick Coupling frame will support the panel assembly. Referring to FIG. 5, the enclosure panels can be assembled without the frames as well where the corners of the enclosures will have the hooks to tie back to existing structures. The enclosure 10 is compact in size. In one embodiment, the enclosure 10 can vary from 2 ft×2 ft×2 ft (60.96 cm×60.96 cm×60.96 cm) to 4 ft×4 ft×4 ft (121.92 cm×121.92 cm×121.92 cm) with various combinations. In one embodiment, the enclosure 10 has a size of about 2.5 ft×2.5 ft×2.5 ft (76.2 cm×76.2 cm×76.2 cm).

Unlike conventional habitat enclosures, the working enclosure 10 of the present invention does not require the presence of the welder or fabricator within the enclosure 10 and perform the hot work therein. Instead, the working enclosure of the present invention allows the welder or fabricator to access the interior of the enclosure by a glove 22 that forms part of the front panel 18 or side panels 12 through a plurality of access ports (not shown) that is positioned on the front panel 18 or side panels 12. Thus the welder/fabricator will insert their hand through the glove section and carry out the job looking through the glass panel 16 using a welding rod 24. The configuration also provides a safer environment to the welder or fabricator as they do not need to be present in the enclosure when performing the hot work. In one embodiment, the glove section comprises at least one protective glove and means for removably attaching said at least one protective glove to the access ports for providing the user a gloved access into the enclosure through the access port for conducting hot work in the enclosure.

During work, the enclosure 10 will be slightly pressurized using air introduced into the enclosure through an air inlet pipe 26 through an air inlet port by blower 28. To ensure that the air being introduced into the enclosure 10 is clean, a gas detector 30 is located at the intake of the blower 28 which is kept in a safe and clean air location. Unlike the conventional habitats, the working enclosure 10 of the present invention is only designed to monitor air quality for the presence of explosive gas and it does not require monitoring the breathing air quality as the welder or fabricator is not working inside the enclosure 10. Also temperature is not required to be monitored or controlled within the habitat as personnel are outside the enclosure. In one embodiment, the pressure inside the working enclosure 10 is maintained at least at 30 Pascal so as to prevent ingress of any inflammable gas into the enclosure 10. If the pressure drops down below 30 Pascal, then alarm and hooter will be triggered and power supply for the hot works will be cut off immediately. In case of emergency, delay timer will be provided to keep the warning light and hooter on for a minute or longer.

One side panel of the enclosure 10 (preferably the opposite side of the panel with the air inlet to the enclosure) is connected to an outlet pipe 32 through an air outlet port. Optionally, the outlet pipe 32 may be connected to another blower 34 that assists in removing air from the enclosure 10. In one embodiment, the outlet pipe 32 is connected with a valve to throttle the air outlet. Light 36 may be provided to ensure that the enclosure 10 is sufficiently illuminated.

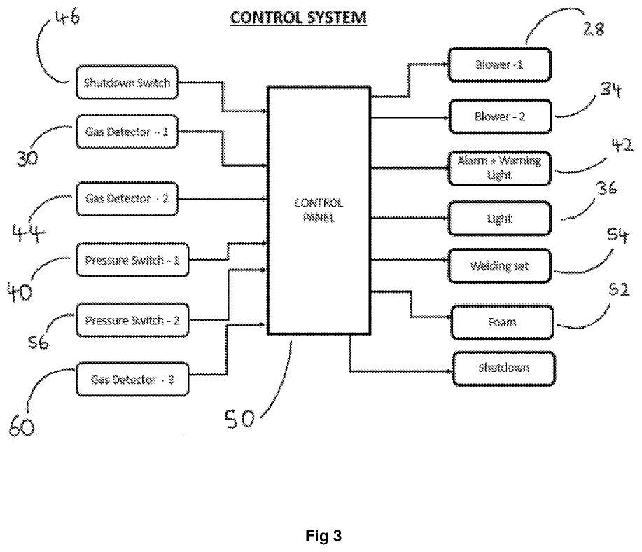

A further gas detector 44 is provided in the inlet point of the blower and inside the enclosure. Gas detector 30 and 44 will trigger shutdown of all systems in case of a flammable gas detection. Also, an emergency shutdown switch 46 (only indicated in the control system in FIG. 3), which will be provided close to the proximity of the technicians at work, can trigger a shutdown manually in the event of an emergency.

In case of an emergency inside the enclosure 10, a retardant, such as foam and/or suppressant, can be injected into the enclosure 10 using a retardant outlet 38 (optional) through activation of foam solenoid 52 by the control panel. These are required only in the highly sensitive area which is not common. This is an additional safety feature compared to the conventional habitat.

All of the components are explosive proof. The panels are made of silica and ceramic. The panels are made to be disposable. This allows an enclosure 10 to be custom made for a specific requirement. Noting that at any one time there may be multiple enclosures on, for example, on oil rigs, this leads to a great advantage over conventional enclosures currently in use.

The panels includes silica/ceramic panel sheets, which are replaceable, and they will be a consumable enabling the user to custom build a suitable enclosure.

In an alternate embodiment the provision of the blowers may be eliminated if one provides inert gas/nitrogen into the enclosure 10 using a bottle through a nozzle, preferably a compressed air or inert gas supply port (58). This may be advantageous especially when working in an area where it may be difficult to access external air, or the welding needs to be conducted in a condition where inert gas is required to be present always. This option is not possible in conventional habitat. Also compressed air can be used wherever it is easily available and which can replace the blower requirement and hence further reducing the operating cost. In normal oil and gas facility in offshore, filtered compressed air is always available for use.

In one embodiment, a similar enclosure, but only with pressure switch 56 and gas detector 60, will be used together with the various equipment such as welding machine 54, welding generator, and etc. Pressure switch 56 and gas detector 60 will be integrated to the control panel 50. Hence welding sets can be operated in the hazardous environment. The welding set together with entire system will be shutdown in the event of a pressure drop or flammable gas detection.

During the operation, if the pressure is dropped or explosive gas is detected, the entire power to enclosure 10 will be shut down and no energy source will be on. In conventional habitat, this is not achievable and hence will not be able to provide high safety shield to the personnel and asset.

In summary, working enclosure 10 of the present invention is multiple times safer, faster and compact for minor hot works compared to the conventional hot work habitats that are currently available in the industry.

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Such improvements may include, but not limited to, collapsible frame to support the enclosure for easy and faster installation, Welding machine enclosure with collapsible type setup (umbrella type) and Spherical type enclosure with few penetration entries for straight installation capabilities. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

### DRAWING COMPONENTS

The drawings include the following integers.
10 enclosures
12 side/rear panels
14 penetration panel
16 glass panel
18 front panel (glove Panel)
20 sample structure for welding
22 glove
24 welding rod
26 air inlet
28 blower 1
30 gas detector1
32 air outlet
34 blower 2
36 light
38 foam/retardant outlet
40 pressure switch 1
42 alarm+warning light linked to hooter.
44 gas detector—2
46 emergency shut down switch
48 hooter (not shown-linked to 42)
50 control panel
52 foam/Suppressant Injection signal
54 welding set signals
56 pressure switch 2 for welding set
58 Compressed air or Inert Gas Supply point
60 Gas Detector —3

1. An enclosure for conducting hot works, the enclosure comprising:
a bottom panel, a top panel, and surrounding side panels extending up from the bottom panel to define an interior,
a plurality of access ports positioned on at least one side impanel; and
at least one glove section positioned on the at least one side panel, wherein the glove section comprises (i) at least one protective glove and (ii) means for removably attaching said at least one protective glove to the access ports for providing a user a gloved access into the enclosure through the access port for conducting hot work in the enclosure.

2. The enclosure of claim 1, wherein the enclosure further comprises:
a front panel that includes at least one transparent panel positioned between the top and the side panels that allows the user to view the interior of the enclosure.

3. The enclosure of claim 1, wherein the enclosure further comprises:
at least one penetration panel configured in a such a manner that it receives a structure that is to be worked on in the enclosure, the penetration panel including a bearing for allowing movement of the structure that is to be worked on.

4. The enclosure of claim 1 further comprising:
a control panel including a power switch and a plurality of switch controllers configured to manipulate operations of various equipment associated with the enclosure;
at least one air inlet port;
at least one air outlet port;
a gas detection unit for detecting presence of explosive gases in the enclosure;
a pressure detection unit; and
an automatic emergency shutdown switch coupled with the gas detection unit and the pressure detection unit for sensing occurrence of an emergency situation in the enclosure and cutting off all the power supply to the enclosure as well as to various equipment associated with the hot work to be conducted in the enclosure, when there are emergency situations.

5. The enclosure of claim 1, wherein the enclosure further comprises:
at least one nozzle for supplying compressed air or compressed inert gas to the enclosure.

6. The enclosure of claim 1, wherein the enclosure further comprises:
at least one nozzle for supplying foam or fire suppressants to the enclosure.

7. The enclosure of claim 2 wherein the transparent panel is made up of high impact and flame retardant materials.

8. The enclosure of claim 2, wherein the transparent panel includes a glass explosive-proof panel.

9. The enclosure of claim 1, wherein the enclosure has a size ranging from 2 Feet×2 Feet×2 Feet (60.96 cm×60.96 cm×60.96 cm) to 4 Feet×4 Feet×4 Feet (121.92 cm×121.92 cm×121.92 cm).

10. The enclosure of claim 9, wherein the enclosure has a size of about 2.5 Feet×2.5 Feet×2.5 Feet (76.2 cm×76.2 cm×76.2 cm).

11. The enclosure of claim 1, wherein the bottom, the side panels and the top panel are made of high temperature resistant materials.

12. The enclosure of claim 11, wherein the high temperature resistant materials include silica and ceramic cloth or fabric.

13. The enclosure of claim 1, wherein the bottom panel, the top panel and the side panels are joined by a fastener that is made of high temperature resistant materials.

14. The enclosure of the claim 1, wherein the enclosure is further coated with a liner on its outer surface for an air-sealed condition.

15. The enclosure of claim 14, wherein the liner is made of tarpaulin.

16. The enclosure of claim 1, wherein the enclosure is maintained at a pressure of at least of 30 Pascal so as to inhibit ingress of any inflammable gas into the enclosure.
